(19) United States
(12) Patent Application Publication
(10) Pub. No.: US 2022/0212658 A1
(43) Pub. Date: Jul. 7, 2022

(54) PERSONALIZED DRIVE WITH OCCUPANT IDENTIFICATION

(71) Applicant: Toyota Motor Engineering & Manufacturing North America, Inc., Plano, TX (US)

(72) Inventors: Katsumi Nagata, Foster City, CA (US); Kevin Gilleo, Ann Arbor, MI (US); Masashi Nakagawa, Suunyvale, CA (US)

(21) Appl. No.: 17/142,142

(22) Filed: Jan. 5, 2021

(51) Int. Cl. B60W 30/08; B60R 25/31; B60R 25/01; B60R 25/30; B60R 21/015; B60W 60/00; B60W 10/30; B60W 40/08; G06K 9/00

(52) U.S. Cl. CPC B60W 30/08; B60R 25/31; B60R 25/01; B60R 25/305; B60R 21/01512; B60W 2040/0809; B60W 10/30; B60W 40/08; G06K 9/00838; G06K 9/00288; B60W 60/0016

(57) ABSTRACT

Methods and systems for automatically implementing occupant settings in a vehicle. The system includes one or more sensors of a vehicle configured to detect sensor data associated with an identification of an occupant within the vehicle and a location of the occupant within the vehicle. The system also includes an electronic control unit (ECU) of the vehicle communicatively coupled to the one or more sensors and configured to adjust one or more vehicle settings based on the identification of the occupant within the vehicle and the location of the occupant within the vehicle to provide improved safety and convenience.

### BACKGROUND

### 1. Field

This specification relates to a system and a method for detecting occupants in a vehicle and personalizing features of the vehicle based on the detection of the occupants.

### 2. Description of the Related Art

Vehicles may transport people and/or cargo. The people within a vehicle may be located in a seat of the vehicle (e.g., a driver's seat, front passenger's seat, rear driver's side seat, rear passenger's side seat, etc.). The people who occupy these seats may have different physical features and characteristics (e.g., height, weight, build, etc.) as well as personal preferences (e.g., audio or video content preferences, climate control preferences, seat position preferences, etc.). These various physical features, characteristics and preferences may affect the way the vehicle is operated and the comfort of the passengers. For example, a first occupant may prefer a climate control temperature of 75 degrees and a second occupant may prefer a climate control temperature of 62 degrees. When the second occupant sit in a seat previously occupied by the first occupant (from a previous transportation event), the second occupant may have to adjust the climate control temperature to their preference. Making this adjustment each time wastes time and may be an inconvenience to the occupant. In the case of the driver, having to make changes may affect the driver's ability to concentrate on driving. Thus, there is a need for improved systems and methods for detecting occupants in a vehicle and personalizing features of the vehicle based on the detection of the occupants.

### SUMMARY

What is described is a system for automatically implementing occupant settings in a vehicle. The system includes one or more sensors of a vehicle configured to detect sensor data associated with an identification of an occupant within the vehicle and a location of the occupant within the vehicle. The system also includes an electronic control unit (ECU) of the vehicle communicatively coupled to the one or more sensors and configured to adjust one or more vehicle settings based on the identification of the occupant within the vehicle and the location of the occupant within the vehicle.

Also described is a vehicle. The vehicle includes one or more sensors configured to detect sensor data associated with an identification of an occupant within a passenger cabin and a location of the occupant within the passenger cabin. The vehicle also includes an electronic control unit (ECU) communicatively coupled to the one or more sensors and configured to adjust one or more vehicle settings based on the identification of the occupant within the vehicle and the location of the occupant within the vehicle.

Also described is a method for automatically implementing occupant settings in a vehicle. The method includes detecting, by one or more sensors of a vehicle, sensor data associated with an identification of an occupant within the vehicle and a location of the occupant within the vehicle. The method also includes identifying the occupant based on the sensor data. The method also includes determining the location of the occupant within the vehicle based on the sensor data. The method also includes adjusting, by an electronic control unit (ECU) of the vehicle, one or more vehicle settings based on the identification of the occupant within the vehicle and the location of the occupant within the vehicle.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1A illustrates a vehicle with occupants approaching the vehicle, according to various embodiments of the invention.

FIG. 1B illustrates the vehicle with occupants inside of the vehicle and recognized by the vehicle, according to various embodiments of the invention.

FIG. 1C illustrates an interior of the vehicle, according to various embodiments of the invention.

FIG. 2A illustrates adjustment of seat belts, according to various embodiments of the invention.

FIG. 2B illustrates adjustment of airbags, according to various embodiments of the invention.

FIG. 2C illustrates adjustment of seats, according to various embodiments of the invention.

FIG. 2D illustrates adjustment of climate control, according to various embodiments of the invention.

FIG. 2E illustrates adjustment of content for rear occupants, according to various embodiments of the invention.

FIGS. 3A and 3B illustrate adjustment of vehicle trajectory, according to various embodiments of the invention.

FIG. 4 illustrates the system, according to various embodiments of the invention.

FIG. 5 illustrates a process of the system, according to various embodiments of the invention.

### DETAILED DESCRIPTION

Disclosed herein are systems, vehicles, and methods for automatically implementing occupant settings in a vehicle. The systems and methods described herein use a plurality of sensors of the vehicle to detect sensor data, which is used to determine an identification of an occupant and a location of the occupant within the vehicle. One or more vehicle settings may be adjusted based on the determination of the identity of the occupant and the location of the occupant within the vehicle.

Conventional vehicles are not capable of identifying the occupants of the vehicle. Thus, in conventional vehicles, the occupant has to manually adjust the settings to the occupant's specifications each time the occupant is in the vehicle. In many cases, the occupant may not bother to adjust the settings each time the occupant enters a vehicle. In some situations, these settings may impact the safety of the occupant, and the occupant not adjusting the settings may impact the safety of the occupant. For example, an occupant may not adjust a seat belt height each time the occupant enters a vehicle. However, using an inappropriate seat belt height may result in harm to the occupant in the event of a collision or a sharp or hard braking event.

The systems and methods described herein automatically adjust the vehicle settings to improve the safety of occupants within the vehicle. The systems and methods described herein also improve the comfort of the occupants within the vehicle. The systems and methods described herein may be particularly useful in the context of ridesharing or rental vehicle usage, as in those contexts, the turnover of occupants is relatively high, compared to a family vehicle, for example, where occupants may regularly occupy the same seat of the vehicle across driving sessions. The systems and methods described herein may also be useful in the context of autonomous and semi-autonomous vehicles.

As used herein, “driver” may refer to a human being driving the vehicle when the vehicle is a non-autonomous vehicle, and/or “driver” may also refer to one or more computer processors used to autonomously or semi-autonomously drive the vehicle. “User” may be used to refer to the driver or occupant of the vehicle when the vehicle is a non-autonomous vehicle, and “user” may also be used to refer to an occupant of the vehicle when the vehicle is an autonomous or semi-autonomous vehicle.

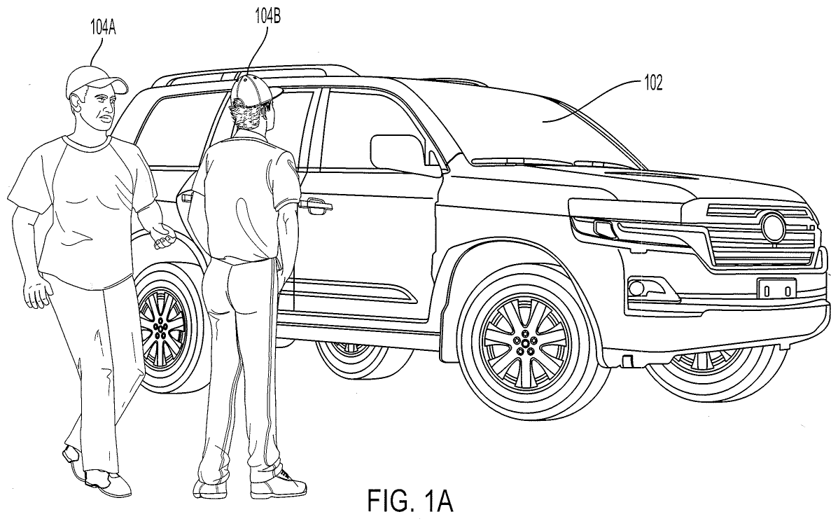

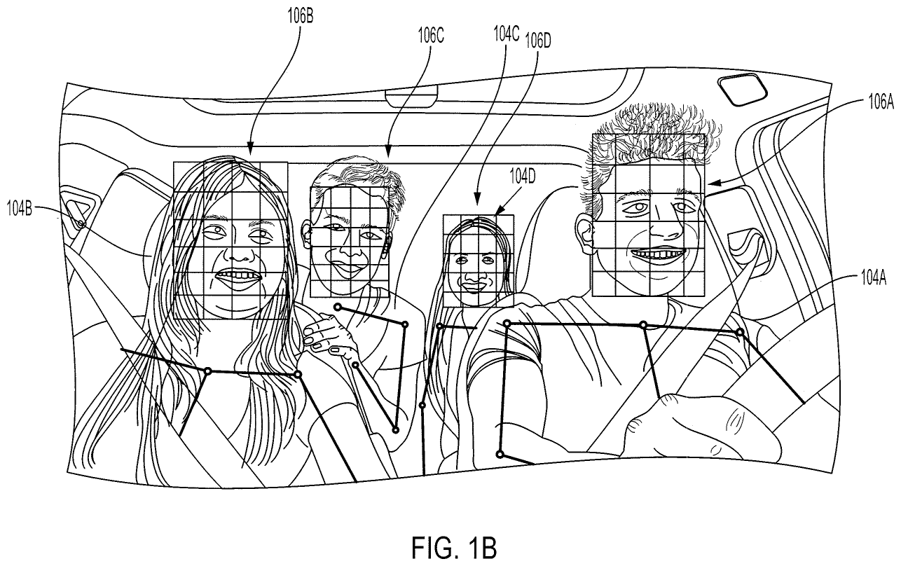

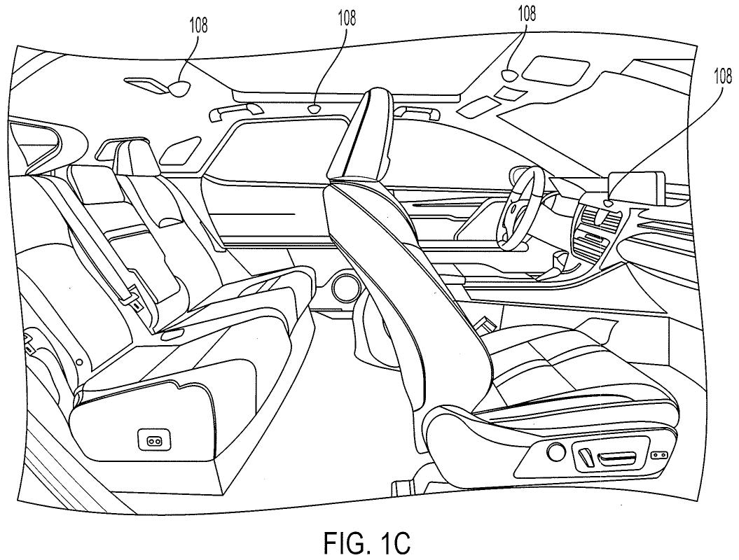

FIG. 1A illustrates a vehicle 102 and multiple potential occupants 104A, 104B approaching the vehicle 102. The vehicle 102 may be any vehicle configured to transport occupants. For example, the vehicle 102 may be a sedan, a coupe, a truck, or a sport utility vehicle, for example.

As will be described herein, the vehicle 102 is capable of identifying an occupant of the vehicle 102 and adjusting one or more settings based on the identification of the occupant. In some embodiments, the vehicle 102 identifies the occupant when the occupant is within the passenger cabin of the vehicle 102. In some embodiments, the vehicle 102 is capable of identifying the occupants 104A, 104B even as they approach the vehicle 102.

The vehicle 102 may have one or more sensors configured to identify the occupants (or potential occupants) 104A, 104B as they approach the vehicle 102. The one or more sensors may include an image sensor configured to detect image data of the occupants 104. The facial recognition may be performed on the detected image data to identify the occupants 104. The facial recognition performed may use machine learning and/or artificial intelligence techniques. The facial recognition may be performed locally by a computing device of the vehicle 102, or the image data may be communicated to a remote data server for facial recognition. The facial recognition can also be performed by the occupant's mobile device 422 and/or the facial recognition data can be automatically transferred from the occupant's electronic device (e.g., mobile device 422) to the vehicle 102 when the occupant is within a predetermined distance from the vehicle 102.

The one or more sensors may also include a transceiver configured to communicate and receive signals from an electronic device of the occupant 104. For example, the first occupant 104A may be wearing a smartwatch configured to broadcast signals identifying the first occupant 104A using the Bluetooth communications protocol, and the second occupant 104B may have a smartphone in their possession configured to identify the second occupant 104B using NFC. In some cases, multi-factor authentication may be used to identify the occupant 104. For example, the second occupant 104B may be identified with NFC as well as facial recognition or other methods of biometric authentication. When the occupant 104 is identified, various characteristics and preferences associated with the occupant 104 may be referenced.

In some embodiments, the vehicle 102 is unable to identify the occupant 104 outside of the vehicle 102 but may be able to detect physical characteristics of the occupant 104. For example, the vehicle 102 may not be able to identify the occupant 104 but may be able to detect that the height, build, approximate weight, approximate age, use of any assistive devices (e.g., wheelchair, cane, stroller) and any other physical characteristics by analyzing sensor data (e.g., image data detected by image sensors). The vehicle 102 may also be able to detect which seat of the vehicle 102 the occupant occupies once the occupant enters the vehicle 102. The vehicle 102 may be able to provide a partial customization of the vehicle settings based on physical characteristics of the occupant, including safety settings.

FIG. 1B illustrates occupants 104 (e.g., a driver 104A, a front passenger 104B, a rear passenger's side occupant 104C, and a rear driver's side occupant 104D) within the passenger cabin of the vehicle 102.

The vehicle 102 may have one or more sensors within the passenger cabin of the vehicle configured to identify the occupants 104 within the vehicle 102. The one or more sensors may include an image sensor configured to detect image data of the occupants 104, including the faces 106 (e.g., faces 106A, 106B, 106C, and 106D) of the occupants 104. Facial recognition may be performed on the detected image data to identify the occupants 104. The facial recognition performed may use machine learning and/or artificial intelligence techniques. The facial recognition may be performed locally by a computing device of the vehicle 102, or the image data may be communicated to a remote data server for facial recognition.

The one or more sensors may also include a transceiver configured to communicate and receive signals from an electronic device of the occupant 104. For example, the first occupant 104A may be wearing a smartwatch configured to broadcast signals identifying the first occupant 104A using the Bluetooth communications protocol, and the second occupant 104B may have a smartphone in their possession configured to identify the second occupant 104B using NFC. When the occupant 104 is identified, various characteristics and preferences associated with the occupant 104 may be referenced.

The one or more sensors may also include a microphone configured to receive audio data from each occupant 104. One or more of the occupants may have a conversation with the vehicle 102 (e.g., a microphone of the vehicle 102) to identify themselves, and voice recognition software may be used to identify the one or more occupants. The voice recognition may be performed locally by a computing device of the vehicle 102, or the audio data may be communicated to a remote data server for voice recognition. Additionally, other biometric authentication may be used to identify each occupant 104.

In some embodiments, the vehicle 102 is unable to identify the occupant 104 inside of the vehicle 102 but may be able to detect physical characteristics of the occupant 104. For example, the vehicle 102 may not be able to identify the occupant 104 but may be able to detect that the height, build, approximate weight, approximate age, use of any assistive devices (e.g., wheelchair, cane, stroller) and any other physical characteristics by analyzing sensor data (e.g., image data from image sensors, weight data from weight sensors in the vehicle). The vehicle 102 may be able to provide a partial customization of the vehicle settings based on physical characteristics of the occupant, including safety settings.

In some embodiments, when the vehicle 102 identifies an occupant, the vehicle 102 will present the identification to the occupants. The identification may be provided in a visual or audible manner. For example, the identification may be provided by displaying the identified occupants on a display screen of the vehicle (e.g., a display screen of an infotainment unit). In another example, the identification may be provided by announcing the identified occupants using a speaker of the vehicle. The vehicle 102 may identify the occupant by name, a username, a globally unique identification (GUID), or any other identifying manner.

In situations where the vehicle 102 incorrectly identifies (or is unable to identify) one or more occupants, the one or more misidentified (or unidentified) occupants may correct (or provide) their identification using an input device (e.g.; touchscreen of an infotainment unit, a keyboard, a button, a microphone). For example, Occupant D may be misidentified as Occupant J. The vehicle 102 may present the identifications using a display screen or a speaker (e.g., “Occupant A is in the driver's seat and Occupant J is in the front passenger's seat” or “Occupant A is in the driver's seat and unable to identify occupant in the front passenger's seat”). Occupant D may then use an input device to correct the identification of Occupant J to Occupant D or to identify the occupant in the front passenger's seat as Occupant D. The vehicle 102 may further refine its occupant identification abilities (e.g., using machine learning or artificial intelligence techniques) based on the corrected identification of Occupant D. Occupant D may provide a name, a username, a globally unique identification (GUID), or any other identifying manner using the input device.

FIG. 1C illustrates possible location of sensors 108 within the passenger cabin of the vehicle 102. The sensors 108 may be image sensors configured to detect image data. The sensors 108 may be positioned within the passenger cabin so that they have a view of each of the faces of the occupants of the vehicle 102, For example, the sensors 108 may be located on a ceiling of the vehicle, along the instrument panel of the vehicle, or on headrests of the vehicle. The sensors 108 may be spatial sensors, such as RADAR or LIDAR, which may be used to detect the presence of occupants in certain seats of the vehicle. The sensors 108 may also be infrared sensors configured to detect infrared data, which may indicate heat emitted by the occupant. Steps may be taken based on the temperature of the occupant, such as adjusting climate control settings or seat settings (e.g., seat warmer or seat cooler). The sensors 108 may be an infrared sensor or a laser to detect and/or measure heart rate or other physical characteristics of the occupant.

Various adjustments may be made by the vehicle 102 based on the identification of the occupants. These adjustments may improve the safety and comfort of the occupants.

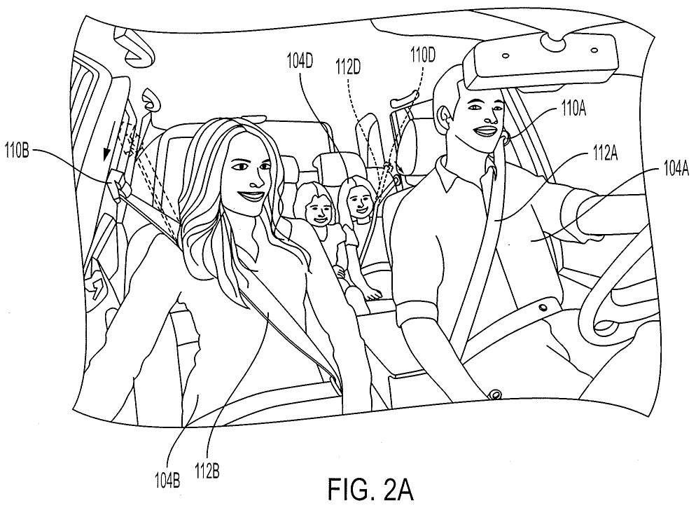

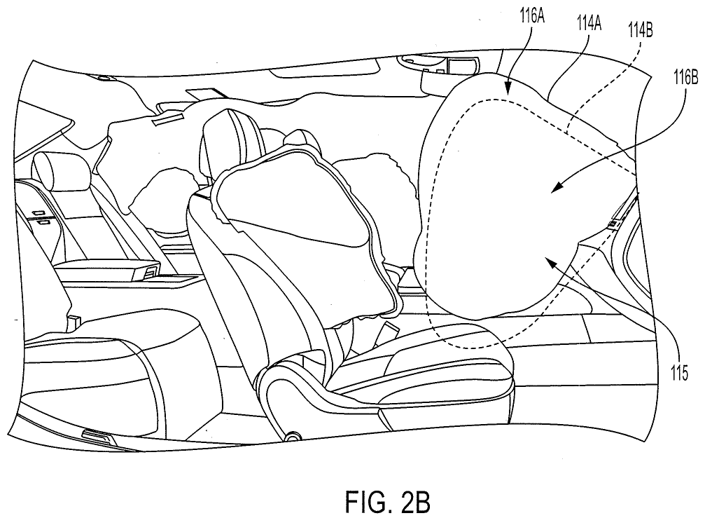

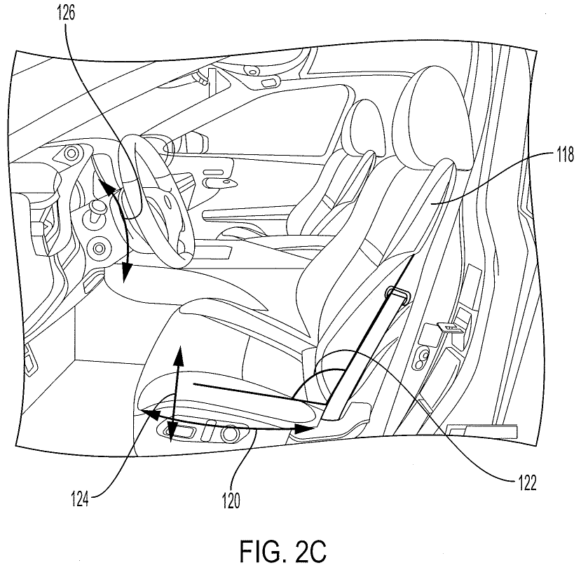

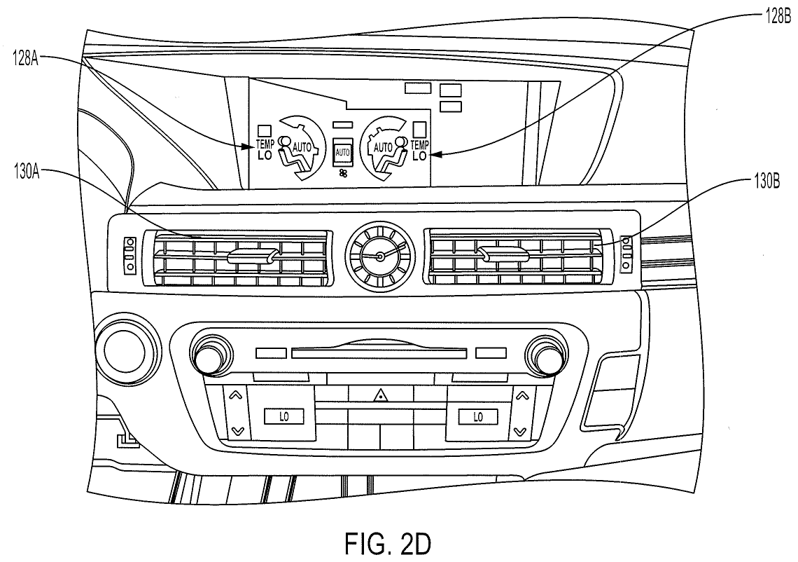

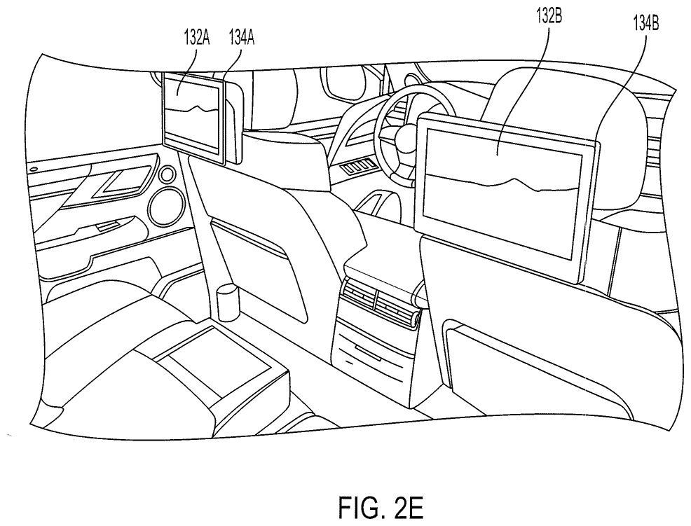

FIG. 2A illustrates seat belts being automatically adjusted based on the occupant identification. The vehicle 102, upon identifying each occupant (or detecting physical characteristics of each occupant), may automatically adjust a height of the seat belt with each seat position setting. The seat belt height, which may be the height of the connection between the seat belt and the vehicle at the occupant's shoulder, may be adjusted by moving the seat belt height adjuster 110 vertically. For example, the driver 104A shown in FIG. 2A is taller than the passenger 104B. The occupant 104D in the seat behind the driver 104A is a child. The driver's seat belt height adjuster 110A is at a higher setting than the passenger's seat belt height adjuster 110B, as the driver is taller than the passenger. The child's seat belt height adjuster 110D may be at an even lower height than the passenger's. Having the appropriate height of the seat belt 112 (e.g., seat belts 112A, 112B, 112D) provides improved safety to the occupant, as well as improved comfort.

Conventionally, when seat belt heights can only be manually adjusted, the last seat belt height setting used by the previous occupant may also be used by subsequent occupants, as the subsequent occupants may not take the time to adjust the seat belt height or may not be aware how to adjust the seat belt height, as seat belt height adjustment mechanisms may vary across manufacturers or even models of vehicles. In addition, it may also be challenging to achieve the same seat belt height each time the seat belt height is adjusted or the seat position is changed. Thus, a sub-optimal seat belt height may be used by many occupants. Seat belts having a height higher than is appropriate for the occupant may chafe on the occupant's neck, or may even injure the occupant in the event of a collision. Seat belts having a lower height than is appropriate for the occupant may result in reduced effectiveness of restraining the occupant in the event of a collision.

The seat belt height adjusters 110 may be automatically moved vertically using one or more actuators. The seat belt height adjusters 110 may also be moved manually by the occupant, either by providing an input to move the seat belt height adjuster 110 using the one or more actuators, or by engaging one or more buttons or levers for physically moving the height of the seat belt height adjuster 110 by the occupant. The vehicle 102 may detect the updated height of the seat belt, record the updated height, and may automatically use the updated height in subsequent instances where the occupant is identified as being in the vehicle 102.

For example, the vehicle may automatically set a seat belt height for the passenger based on the passenger's physical characteristics. If the passenger prefers the seat belt height to be a bit higher, the passenger may adjust the seat belt height to be higher (e.g., manually or using one or more actuators). The vehicle may record this updated height and use the updated height each time the passenger enters the vehicle. In this way, no matter where the occupant is located within the vehicle, the vehicle will automatically provide the appropriate seat belt height for the passenger.

The vehicle 102 may also detect whether the seat belt is being worn correctly. Some occupants may choose to adjust or place both arms on the same side of the shoulder strap of the seat belt or may wear the seat belt such that the shoulder strap is behind the occupant's back. Wearing seat belts improperly reduces the effectiveness of the seat belt and reduces safety of the occupant within the vehicle. Thus, the vehicle 102 may provide an alert or notification to the driver or user when it detects a seat belt is being worn incorrectly.

For example, the vehicle 102 may use one or more image sensors within the passenger cabin to identify whether each occupant is correctly wearing their seat belt 112. The image data may be analyzed to determine whether the shoulder strap is located across the body of the occupant and the lap strap is located across the lap of the occupant. Analysis and notifications may be adjusted based on any physical features of the occupant. For example, if the occupant is pregnant, the vehicle 102 may detect whether the lap strap of the seat belt is over the belly or under the belly. When the lap strap is over the belly, a sudden tightening of the lap strap may be potentially dangerous to the pregnant occupant.

The notifications may be a visual notification (e.g., on a display of an infotainment unit, a display within the instrument panel in front of the driver, or in a heads-up display projected onto a window), an audible notification (e.g., using a speaker to provide spoken warnings or to provide audible beeps), or a tactile notification (e.g., using a vibration unit in the seat, for example, to provide haptic feedback).

In some embodiments, a tightness of the seat belt may be adjusted by the vehicle based on the physical aspects of the occupant. For example, a greater amount of tension may be used for heavier and/or taller occupants than for lighter and/or shorter occupants.

FIG. 2B illustrates airbags being deployed in the passenger cabin of the vehicle. The airbag 115 can have its orientation, which is the angle in which it is deployed from the vehicle, as well as its inflation, which is the amount of air used to inflate the airbag, adjusted. The airbag 115 may be oriented upward for taller occupants and oriented lower for shorter occupants. The airbag 115 may also be more inflated or less inflated, depending on the size and location of the passenger. The outline 114A illustrates a more upward orientation and the outline 114B illustrates a more downward orientation. The inflation amount 116A is also illustrated as being greater than the inflation amount 116B.

The adjustment of the orientation may be performed by one or more actuators connected to the airbag and the airbag deployment mechanism. The airbag may be located around a pivot or hinge, with the location of the airbag adjustable around the pivot or hinge by one or more actuators controlled by a processor of the vehicle 102 (e.g., an ECU). In some embodiments, the orientation of the airbag may be vertical as well as horizontal. The adjustment of the inflation of the airbag may be performed by the airbag filling mechanism (e.g., a gas canister) responsible for inflating the airbag. The airbag filling mechanism may be a part of the airbag deployment mechanism. The amount of air or gas to use to fill the airbag may be controlled by a processor of the vehicle 102 (e.g., an ECU).

In some embodiments, the occupant's location within the seat may be tracked using one or more sensors (e.g., image sensors), and the airbag deployment may be adjusted based on the occupant's location within the seat. For example, if the occupant is leaning back in the seat with the occupant's body weight shifted toward the occupant's right side, the orientation of the airbag may be angled toward the occupant's right side, and the inflation may be a standard (non-reduced) level of inflation, as the occupant is leaning back.

By customizing the orientation of the airbag, as well as the inflation of the airbag based on the occupant of the vehicle, the safety of the occupants may be increased. Conventional vehicles do not take any occupant-specific information into consideration when deploying airbags.

FIG. 2C illustrates a seat 118 of the vehicle 102. The seat 118 may be adjusted by the occupant using controls. For example, the height 124 of the seat, the angle 122 of the seat, and/or the front/back position 120 of the seat may be adjusted. In some embodiments, the vehicle 102 automatically adjusts the seat based on the physical characteristics of the occupant while maintaining the safest seat position designed for the vehicle. For example, the occupant may be relatively tall, so the seat may be positioned backward with a relatively high seat angle and may also have a low height. The occupant may thereafter adjust the seat according to the occupant's preferences. The vehicle 102 may store the adjusted seat settings for automatic implementation when the vehicle 102 identifies the occupant in subsequent driving sessions. In some embodiments, the preferences may be seat-specific. For example, a first occupant may have different preferences depending on the seat of the vehicle 102. The first occupant may prefer to drive with a relatively low seat angle 122 but may prefer a higher seat angle when in the front passenger's seat. The first occupant may also prefer an even higher seat angle when in a rear passenger's seat. Each seat preference may be stored separately. The occupant may indicate to the vehicle whether the occupant would like their seat preference to be stored on a seat-specific basis.

FIG. 2C also illustrates a steering wheel angle 126. The steering wheel angle 126 may also be adjusted according to the preferences of the driver. In some embodiments, the vehicle 102 automatically sets the steering wheel angle 126 based on the physical characteristics of the driver. The automatically set steering wheel angle 126 may be determined based on optimizing the safety of the driver. The driver may thereafter adjust the steering wheel angle 126, and the vehicle 102 may store the adjusted steering wheel angle for automatic implementation when the vehicle 102 identifies the driver in subsequent driving sessions. While steering wheel angle 126 is illustrated, other steering wheel aspects, such as steering wheel height and steering wheel depth, may also be adjusted.

FIG. 2D illustrates climate control settings of the vehicle 102. Various climate control settings 128 (e.g., climate control settings 128A and 128B) may be adjusted by an occupant, such as temperature, fan speed, whether heating or cooling should be provided to the face or feet. The climate control settings may also include settings associated with the vents 130 (e.g., 130A and 130B), including whether they should be open or closed and the angle of the vents (e.g., up, down, left, right).

In some embodiments, the vehicle 102 automatically sets the climate control settings for each passenger based on the outside and inside ambient air temperatures and the temperature of the occupant. The occupant may thereafter adjust the climate control settings, and the vehicle 102 may store the adjusted climate control settings for automatic implementation when the vehicle 102 identifies the occupant in subsequent driving sessions.

FIG. 2E illustrates display screens 134 (e.g., display screens 134A and 134B) configured to display content 132 (e.g., content 132A and 132B) to rear occupants. The vehicle 102 may identify the occupant and may present content according to the occupant's preferences and access qualifications. The occupant's preferences may include specifically which movies, TV shows, or music the occupant prefers, as well as genres of movies, TV shows, or music. The occupant's access qualifications may include age-based restrictions or subscription-based restrictions. For example, the occupant may be identified as being 8 years old, and accordingly, content identified as being for individuals over 18 years old may not be presented to the occupant. In another example, the occupant may have paid subscriptions to Streaming Service N and Streaming Service H, but not Streaming Service P. Thus, content from Streaming Service N and Streaming Service H may be available to the occupant, but not content from Streaming Service P. The occupant may provide authentication credentials for the paid subscriptions, which may thereafter be associated with the occupant.

Many of the preferences, such as seat preferences, climate control preferences, and entertainment preferences, may be transferred across vehicles. For example, the preferences recorded by a first vehicle for a first occupant may be implemented when the first occupant enters a second vehicle. The occupant's preferences may be stored in a remote data server accessible to many vehicles.

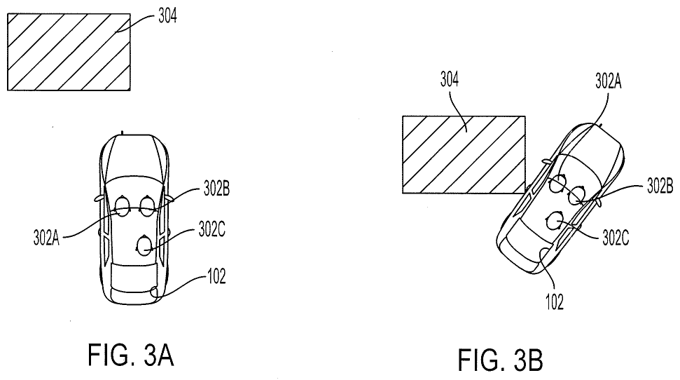

FIGS. 3A and 3B illustrate maneuvers the vehicle 102 may perform based on the identification of occupants in the vehicle 102.

As shown in FIG. 3A, the vehicle 102 may be driving, with a first occupant 302A in the driver's seat, a second occupant 302B in the front passenger's seat, and a third occupant 302C in a rear seat behind the front passenger's seat. The vehicle 102 may detect a potential collision with object 304. The vehicle 102 may autonomously perform maneuvers to mitigate the harm to the occupants 302.

As shown in FIG. 3B, the vehicle 102 may detect the presence of the occupants 302 and the locations of the occupants 302 in the vehicle 102. The vehicle 102, anticipating an imminent collision and knowing that there are no occupants behind the driver 302A, may turn the vehicle 102 to the right so that the collision with the object 304 impacts a location where there is no occupant.

In other situations, the vehicle 102 may not make a maneuver as shown in FIG. 3B when there is an occupant sitting behind the driver. In some embodiments, the vehicle 102 may calculate an aggregate harm to the occupants of the vehicle 102 for each of a number of potential maneuvers made by the vehicle 102, and the vehicle 102 may autonomously maneuver the vehicle according to the potential maneuver with the lowest amount of aggregate harm.

The aggregate harm may factor into account aspects of the occupants, such as age, health condition, height, weight, build, or whether they are asleep or awake, for example.

When a collision has occurred, the vehicle 102 may automatically communicate a distress communication to an emergency service. The distress communication may include a location of the vehicle 102 (e.g., determined using a location sensor, such as GPS), as well as a status of the vehicle and a status of the occupants from the sensors 108.

For example, when an occupant is wearing a device capable of detecting medical data, such as a smartwatch, fitness tracker, or other medical device, the device may be communicatively coupled with the vehicle 102. The device may be initially used to identify the occupant, but may also be used in an emergency situation to provide occupant health data to the emergency service.

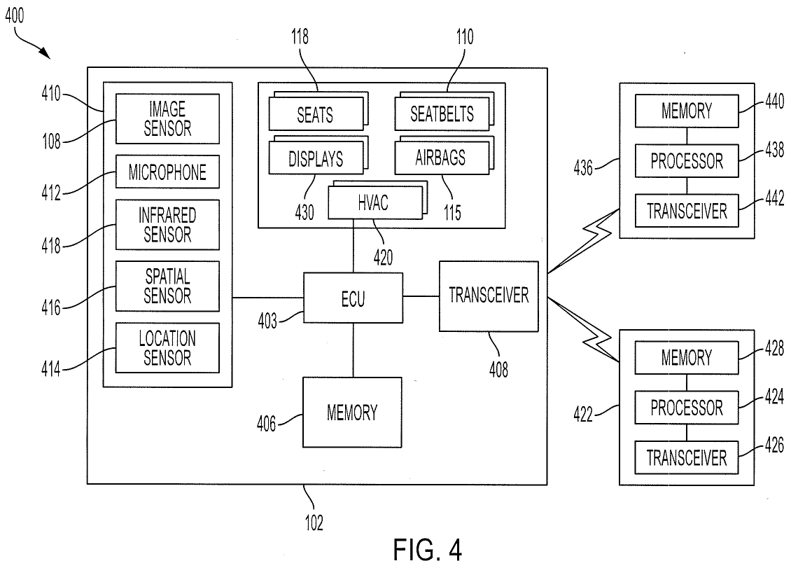

FIG. 4 illustrates an example system 400, according to various embodiments of the invention. The system may include a vehicle 102. The system 400 may also include a mobile device 422 and/or a remote data server 436.

The vehicle 102 may have an automatic or manual transmission. The vehicle 102 is a conveyance capable of transporting a person, an object, or a permanently or temporarily affixed apparatus. The vehicle 102 may be a self-propelled wheeled conveyance, such as a car, a sports utility vehicle, a truck, a bus, a van or other motor or battery driven vehicle. For example, the vehicle 102 may be an electric vehicle, a hybrid vehicle, a plug-in hybrid vehicle, a fuel cell vehicle, or any other type of vehicle that includes a motor/generator. Other examples of vehicles include bicycles, trains, planes, or boats, and any other form of conveyance that is capable of transportation. The vehicle 102 may be a semi-autonomous vehicle or an autonomous vehicle. That is, the vehicle 102 may be self-maneuvering and navigate without human input. An autonomous vehicle may use one or more sensors and/or a navigation unit to drive autonomously.

The vehicle 102 also includes one or more computers or electronic control units (ECUs) 403, appropriately programmed, to control one or more operations of the vehicle 102. The one or more ECUs 403 may be implemented as a single ECU or in multiple ECUs. The ECU 403 may be electrically coupled to some or all of the components of the vehicle 102. In some embodiments, the ECU 403 is a central ECU configured to control one or more operations of the entire vehicle. In some embodiments, the ECU 403 is multiple ECUs located within the vehicle and each configured to control one or more local operations of the vehicle. In some embodiments, the ECU 403 is one or more computer processors or controllers configured to execute instructions stored in a non-transitory memory 406.

Although FIG. 4 illustrates various elements connected to the ECU 403, the elements of the vehicle 102 may be connected to each other using a communications bus.

The transceiver 408 of the vehicle 102 may include a communication port or channel, such as one or more of a Wi-Fi unit, a Bluetooth® unit, a Radio Frequency Identification (RFID) tag or reader, a DSRC unit, or a cellular network unit for accessing a cellular network (such as 3G, 4G, or 5G). The transceiver 408 may transmit data to and receive data from devices and systems not directly connected to the vehicle. For example, the ECU 403 may communicate with the remote data server 436. In some embodiments, the transceiver 408 may be used to determine a location of an occupant within the vehicle. The transceiver 408 may detect a signal strength of a mobile device associated with the occupant, and based on the signal strength of the mobile device, the location of the occupant may be determined. In some embodiments, there may be a plurality of transceivers 408 separated by known distances, and the ECU 403 may be capable of determining the location of a mobile device (and thus the location of the corresponding user) based on the signal strength detected by the plurality of transceivers 408. The transceiver 408 may have the appropriate bandwidth for detection of the various mobile devices.

The vehicle 102 may be coupled to a network using the transceiver 408. The network, such as a local area network (LAN), a wide area network (WAN), a cellular network, a digital short-range communication (DSRC), the Internet, or a combination thereof, connects the vehicle 102 to a remote data server 436. The remote data server 436 may include a non-transitory memory 440, a processor 438 configured to execute instructions stored’ in the non-transitory memory 440, and a transceiver 442 configured to transmit and receive data to and from other devices, such as vehicle 102. Transceiver 442 may be similar to transceiver 408.

The remote data server 436 may be one or more servers from different service providers. Each of the one or more servers may be connected to one or more databases. A service provider may provide navigational map, weather and/or traffic data to the vehicle.

A database is any collection of pieces of information that is organized for search and retrieval, such as by a computer or a server, and the database may be organized in tables, schemas, queries, report, or any other data structures. A database may use any number of database management systems and may include a third-party server or website that stores or provides information. The information may include real-time information, periodically updated information, or user-inputted information. A server may be a computer in a network that is used to provide services, such as accessing files or sharing peripherals, to other computers in the network. A website may be a collection of one or more resources associated with a domain name.

The navigational map information includes political, roadway and construction information. The political information includes political features such as cities, states, zoning ordinances, laws and regulations, and traffic signs, such as a stop sign, or traffic signals. For example, laws and regulations may include the regulated speed on different portions of a road or noise ordinances. The roadway information includes road features such the grade of an incline of a road, a terrain type of the road, or a curvature of the road. The construction information includes construction features such as construction zones and construction hazards.

The vehicle 102 includes a sensor array 410 connected to the ECU. The sensor array includes image sensors 108, a microphone 412, a location sensor 414, a spatial sensor (e.g., RADAR or LIDAR) 416, and/or an infrared sensor 418, each as described herein.

The image sensors 108 are configured to detect image data within the passenger cabin of the vehicle 102. The image sensors 108 may also be configured to detect image data outside of the vehicle 102 for identifying potential occupants before they enter the vehicle 102.

The location sensor 414 is configured to determine location data. The location sensor 414 may be a GPS unit or any other device for determining the location of the vehicle 102. The ECU 403 may use the location data along with the map data to determine a location of the vehicle. In other embodiments, the location sensor 414 has access to the map data and may determine the location of the vehicle and provide the location of the vehicle to the ECU 403.

The spatial sensor 416 may be used with the image data from the image sensor 108 to identify occupants as well as locations of the occupants within the vehicle 102. The spatial data from the spatial sensor 416 may verify determinations made using the image data, or the spatial data alone may be used to identify occupants and/or locations of the occupants within the vehicle 102.

The infrared sensor 418 may be used to detect infrared data, which may indicate heat emitted by the occupant. Steps may be taken based on the temperature of the occupant, such as adjusting climate control settings or seat settings (e.g., seat warmer or seat cooler).

The ECU 403 may use multiple sensors to detect and confirm the identity and the location of the occupant. Where there is a conflict, there may be a priority order of sensors to trust, or there may be a protocol to not take action when the identity and/or the location of the occupant within the vehicle cannot be confirmed. For example, a first sensor may detect Occupant A in a first seat, but a second sensor may detect Occupant A in a second seat. In some embodiments, the first sensor may be determined to be more reliable than the second sensor, so the vehicle may proceed with the determination that Occupant A is in the first seat. In other embodiments, the vehicle may not provide any automatic customization of one or more vehicle features until all sensor detections are consistent. In some embodiments, vehicle feature adjustments may each have their own requirements for sensor consistency. For example, any safety related vehicle feature adjustments may require all sensors (or a threshold number or percentage of sensors) to agree regarding the identity and/or the location of the occupant within the vehicle. In another example, comfort related vehicle feature adjustments may be implemented even though one or more sensors may not be working.

The memory 406 is connected to the ECU 403 and may be connected to any other component of the vehicle. The memory 406 is configured to store any data described herein, such as the map data, the location data, occupant data, and any data received from the remote data server 436 via the transceiver 408.

The vehicle 102 also includes various devices, such as seats 118, seatbelts 110, displays 430, airbags 115, and heating, ventilation and air conditioning (HVAC) 420 for example, that may be controlled by the ECU 403. As described herein, the seats 118 may be adjusted by the ECU 403 based on identification of the occupant sitting in the seat 118, the seatbelts 110 may be adjusted by the ECU 403 based on identification of the occupant using the seatbelt 110, the content of the displays 430 may be adjusted by the ECU based on identification of the occupant viewing the display 430, airbags 115 may be adjusted by the ECU 403 based on identification of the occupant in the corresponding seat, and HVAC 420 may be adjusted by the ECU 403 based on the identification of the occupant in the corresponding seat and/or current conditions of the occupant in the corresponding seat.

The display 430 may be a display located in the infotainment unit, the instrument panel in front of the driver, or any other location within the passenger cabin of the vehicle 102. The display 430 may be a touchscreen display configured to receive input from the user. In addition to the display 430, the vehicle 102 may also include other output devices, such as speakers or vibration units for providing information or notifications to the user. In addition to the display 430 being a touchscreen display, the vehicle 102 may also include other input devices, such as buttons, knobs, touchpads, or microphones, for receiving user input.

Also included in the system is a mobile device 422, which includes a processor 424 configured to execute instructions stored in non-transitory memory 428. The mobile device 422 also includes a transceiver 426 similar to transceiver 408 and transceiver 442. The mobile device 422 also includes an input/output device configured to receive inputs from the user and display outputs to the user, as described herein. The input/output device may be an input device (or input unit) such as a touchscreen, a microphone, a stylus, or a keyboard and an output device (or output unit) such as a touchscreen, a display screen, or a speaker.

As described herein, the mobile device 422 may be any computing device configured to communicate with the vehicle 102, such as a smartphone, a smartwatch, a fitness tracker, a medical device, or a tablet, for example. The mobile device 422 may communicate data to the vehicle 102 via respective transceivers that the vehicle 102 may use to identify an occupant associated with the mobile device 422. For example, the mobile device 422 may be a smartwatch of an occupant, and the smartwatch may be configured to communicate with the vehicle 102 using one or more wireless communications protocols, such as Bluetooth or WiFi, for example. The smartwatch may communicate identification data to the vehicle 102 regarding the occupant who is wearing the smartwatch. For example, the smartwatch may communicate a name or a GUID to the vehicle 102, and the vehicle 102 may use the name or GUID to identify the occupant. The mobile device 422 may be a handheld device such as a cell phone.

In some embodiments, the mobile device 422 may communicate occupant data, such as health data associated with the occupant, which the vehicle 102 may use. For example, in the event of an emergency, the vehicle 102 may provide the health data to emergency responders. Emergency responders may be able to identify which occupant may have sustained more severe injury or whether any of the occupants are in critical condition. In another example, the vehicle 102 may receive temperature data associated with the occupant, and the vehicle 102 may automatically turn on an air conditioning unit or lower the climate control settings for the occupant. The mobile device 422 may also be used to determine a relative location of the occupant within the vehicle 102. For example, the mobile device 422 may include an ultra-wideband chip, an RFID chip, or an NFC tag, which a corresponding sensor of the vehicle 102 may use to determine a location of the mobile device (and therefore, the associated occupant) within the vehicle 102.

As used herein, a “unit” may refer to hardware components, such as one or more computer processors, controllers, or computing devices configured to execute instructions stored in a non-transitory memory.

As used herein, when a device is referred to as performing a function, one or more components of the device may perform the function. For example, the vehicle 102 receiving identification data from the mobile device 422 may be a transceiver of the vehicle 102 receiving the identification data, and the vehicle 102 adjusting one or more vehicle settings (e.g., seat settings, seat belt settings, display settings, airbag settings, climate control settings) for the occupant may be the ECU of the vehicle 102 adjusting the one or more vehicle settings for the occupant.

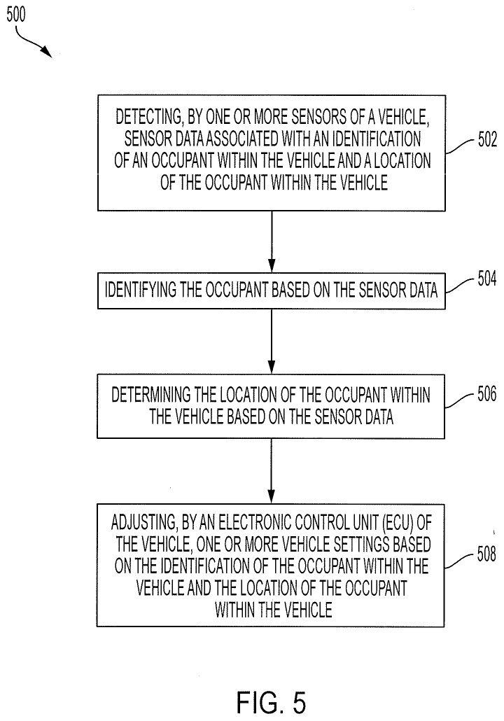

FIG. 5 illustrates a process 500 performed by the systems described herein. One or more sensors (e.g., sensors 410) of a vehicle (e.g., vehicle 102) detect sensor data associated with an identification of an occupant within the vehicle and a location of the occupant within the vehicle (step 502).

For example, the sensors may be one or more image sensors configured to detect image data, and the one or more image sensors may be within the passenger cabin of the vehicle or located on an exterior of the vehicle.

The occupant may be identified based on the sensor data (step 504). Using the sensor data, an ECU (e.g., ECU 403) of the vehicle or a processor (e.g., processor 438 or processor 424) may determine the identity of the occupant. The occupant may be identified using machine learning techniques and/or artificial intelligence. For example, when the sensor data is image data, facial recognition may be used to identify the occupant. In another example, when the sensor data is user data from a mobile device of the occupant (e.g., a smartwatch or fitness tracker), the user data may be used to identify the occupant. In some embodiments, using the identity of the occupant, one or more aspects of the occupant (e.g., physical characteristics, preferences, health information) may be referenced from a memory (e.g., memory 406, memory 440, memory 428). In some embodiments, when the occupant is unable to be identified, one or more characteristics of the occupant may be identified based on the sensor data, such as height or overall build.

The location of the occupant is determined based on the sensor data (step 506). Using the sensor data, the ECU of the vehicle or a processor (e.g., of a remote data server or a mobile device) may determine the location of the occupant in the vehicle. The ECU of the vehicle or the processor may identify the location of the occupant in the vehicle based on the known location of the sensor providing the sensor data. For example, if a sensor oriented toward a rear passenger's side seat is detecting sensor data associated with an occupant, the occupant's location may be determined based on the location and orientation of the sensor.

The ECU of the vehicle adjusts one or more vehicle settings based on the identification of the occupant within the vehicle and the location of the occupant within the vehicle (step 508).

The one or more vehicle settings may be a seat setting, a seatbelt setting, a display setting, an airbag setting, and/or an HVAC setting, as described herein. The one or more vehicle settings may also be a manner in which the vehicle is autonomously driven, also as described herein. For example, the vehicle may be autonomously driven in a way to reduce injury to the occupants of the vehicle based on the identification of the occupants and the location of the occupants in the vehicle.

As used herein, “substantially” may refer to being within plus or minus 10% of the value.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A system for automatically implementing occupant settings in a vehicle, the system comprising:
one or more sensors of a vehicle configured to detect sensor data associated with an identification of an occupant within the vehicle and a location of the occupant within the vehicle; and
an electronic control unit (ECU) of the vehicle communicatively coupled to the one or more sensors and configured to adjust one or more vehicle settings based on the identification of the occupant within the vehicle and the location of the occupant within the vehicle.

2. The system of claim 1, wherein the one or more sensors include one or more image sensors configured to detect image data, and
wherein the image data is analyzed to determine the identification of the occupant within the vehicle.

3. The system of claim 2, wherein the one or more image sensors are within a passenger cabin of the vehicle.

4. The system of claim 1, further comprising a memory configured to store occupant data including one or more vehicle settings associated with the occupant, and
wherein the ECU adjusts the one or more vehicle settings based on the stored occupant data.

5. The system of claim 1, wherein the one or more vehicle settings include a seat setting, and wherein the ECU is configured to automatically adjust a seat corresponding to the occupant.

6. The system of claim 1, wherein the one or more vehicle settings include a seat belt setting, and wherein the ECU is configured to automatically adjust a seat belt height of a seat belt corresponding to the occupant.

7. The system of claim 1, wherein the one or more vehicle settings include a display setting, and wherein the ECU is configured to automatically adjust content displayed on the display screen based on the identification to the occupant.

8. The system of claim 1, wherein the one or more vehicle settings include an HVAC setting, and wherein the ECU is configured to automatically adjust a climate control setting associated with the location of the occupant.

9. The system of claim 1, wherein the one or more vehicle settings include an airbag setting, and wherein the ECU is configured to automatically adjust at least one of a deployment angle of an airbag or an inflation amount of an airbag based on the identification of the occupant.

10. The system of claim 1, wherein the ECU is further configured to automatically maneuver the vehicle to mitigate injury to all occupants of the vehicle in a detected collision based on the location of all occupants of the vehicle within the vehicle.

11. A vehicle comprising:
one or more sensors configured to detect sensor data associated with an identification of an occupant within a passenger cabin and a location of the occupant within the passenger cabin; and
an electronic control unit (ECU) communicatively coupled to the one or more sensors and configured to adjust one or more vehicle settings based on the identification of the occupant within the vehicle and the location of the occupant within the vehicle.

12. The vehicle of claim 11, wherein the one or more sensors include one or more image sensors configured to detect image data, and
wherein the image data is analyzed to determine the identification of the occupant within the vehicle.

13. The vehicle of claim 11, further comprising a memory configured to store occupant data including one or more vehicle settings associated with the occupant, and
wherein the ECU adjusts the one or more vehicle settings based on the stored occupant data.

14. The vehicle of claim 11, wherein the one or more vehicle settings include at least one of a seat setting or a display setting, and wherein the ECU is configured to automatically adjust a seat corresponding to the occupant or automatically adjust content displayed on the display screen based on the identification to the occupant.

15. The vehicle of claim 11, wherein the one or more vehicle settings include a seat belt setting, and wherein the ECU is configured to automatically adjust a seat belt height of a seat belt corresponding to the occupant.

16. The vehicle of claim 11, wherein the one or more vehicle settings include an HVAC setting, and wherein the ECU is configured to automatically adjust a climate control setting associated with the location of the occupant.

17. The vehicle of claim 11, wherein the one or more vehicle settings include an airbag setting, and wherein the ECU is configured to automatically adjust at least one of a deployment angle of an airbag or an inflation amount of an airbag based on the identification of the occupant.

18. A method for automatically implementing occupant settings in a vehicle, the method comprising:
detecting, by one or more sensors of a vehicle, sensor data associated with an identification of an occupant within the vehicle and a location of the occupant within the vehicle;
identifying the occupant based on the sensor data;
determining the location of the occupant within the vehicle based on the sensor data; and
adjusting, by an electronic control unit (ECU) of the vehicle, one or more vehicle settings based on the identification of the occupant within the vehicle and the location of the occupant within the vehicle.

19. The method of claim 18, wherein the adjusting the one or more vehicle settings includes at least one of automatically adjusting a seat corresponding to the occupant, automatically adjusting a seat belt height of a seat belt corresponding to the occupant, automatically adjusting content displayed on the display screen based on the identification to the occupant, automatically adjusting a climate control setting associated with the location of the occupant, or automatically adjusting at least one of a deployment angle of an airbag or an inflation amount of an airbag based on the identification of the occupant.

20. The method of claim 18, further comprising autonomously maneuvering, by the vehicle, to mitigate harm to occupants of the vehicle in an anticipated collision based on detection of respective occupant identifications and occupant locations within the vehicle.
